(19) United States
(12) Patent Application Publication
(10) Pub. No.: US 2005/0148329 A1
(43) Pub. Date: Jul. 7, 2005

(54) Smartphone profiler system and method

(76) Inventors: Jeffrey Brunet, Toronto (CA); Ian Collins, Markham (CA); Yousuf Chowdhary, Maple (CA); Stephen Kim, Thornhill (CA)

Correspondence Address: RENNER, KENNER, GREIVE, BOBAK, TAYLOR & WEBER, FIRST NATIONAL TOWER FOURTH FLOOR, 106 S. MAIN STREET, AKRON, OH, 44308, US

(21) Appl. No.: 10/999,606

(22) Filed: Nov. 29, 2004

Related U.S. Application Data
(60) Provisional application No. 60/525,794, filed on Dec. 1, 2003.

(51) Int. Cl. H04Q 7/20; H04M 1/68

(52) U.S. Cl. 455/432.2

(57) ABSTRACT

A smartphone profiler system and method is provided for collecting profile data from a mobile device which is then transmitted to a server for analysis and customer care. The profile data may be transmitted in one or more data streams. The invention provides for more than one possible type of transmission protocol. If a transmission fails using a first transmission protocol, the invention allows a second transmission protocol to be used. The server is preferably capable of invoking a corrective action on the mobile device based on the profile data received.

### RELATED APPLICATIONS

This application claims the benefit of U.S. Provisional Application Ser. No. 60/525,794, filed Dec. 1, 2003.

### FIELD OF THE INVENTION

The present invention relates to customer care systems for telecommunications devices, and more particularly, to customer care systems and methods for mobile devices.

### BACKGROUND OF THE INVENTION

For the first time in the history of telecommunications networks, significant computing power has become available to the end user's device. This welcome change has the ability to reshape the architecture of all mobile telecommunications networks. Traditionally the Operational Support Systems/Business Support Systems (OSS/BSS) were large-scale, extremely complex, centralized systems within the network. With the proliferation of next generation smartphones and wireless PDAs, significant intelligence can be pushed out to the subscriber terminal, and thus the ability to greatly simplify OSS/BSS has emerged.

The telecommunications industry is on the verge of a revolution in support system technologies. A rare intersection of technological change has become apparent in the mobile industry. Mobile data networks have been deployed around the world. These networks provide fast reliable packet data to subscriber's mobile devices. At the same time, intelligent mobile devices (smartphones) have emerged as capable computing platforms with considerable processing power, onboard storage and memory.

Smartphones are devices running feature rich operating systems such as Symbian, PalmOS, Microsoft WinCE, BREW (Binary Runtime Environment for Wireless) and Java MIDP compliant devices. Due to the complex nature and multitude of new features, these smartphone devices are difficult to configure, compounded with limited keyboards, entering information such as personal details and configuration settings is not only difficult but also highly prone to human errors. A combination of feature complexity and configuration requirements provides the opportunity to exponentially improve upon the support solutions for wireless network operators. Intelligent client-based Operational Support Systems (OSS) have now become possible.

With the wide availability of downloadable services and applications available for smartphone users, and the increasing costs of customer care, ensuring efficient and less-cumbersome support when problems arise is an increasing necessity. In contrast to traditional customer service applications that are available in contact centers today, CSRs (Customer Service Representatives) must undertake the extensive and time-consuming task of asking customer's complex questions pertaining to their wireless devices for problem diagnosis. This requires CSRs to be experts on smartphones and their applications, and also requires customers to spend an increasing amount of time on the telephone to receive support for their applications. The result is increased support costs, increased call handling times, complex diagnostic processes and overall frustration.

The current method of gathering and obtaining smartphone information required for diagnostics is manual and therefore complex, time consuming and prone to human errors. These methods leave both the subscribers and customer support staff frustrated. In addition, obtaining diagnostic information requires a specialized support staff and contact centers must therefore hire and train specialized staff for specific tasks. For the service provider this means increased hiring and operational costs.

With the emergence of smartphones and wireless PDAs and their ability to download and install applications, the wireless industry is poised to see explosive growth in application usage by subscribers. Mobile operator customer care centers are focused on solutions for closed, voice-centric mobile phones. This infrastructure is not suited to efficiently solve the intelligent mobile data device and application problems described above. The proliferation of next generation “smartphone” devices and the level of issues and problem solving needed, require a customer care application specifically tailored to meet these emerging business needs.

### SUMMARY OF THE INVENTION

The present invention comprises a Smartphone Profiler System and Method. The invention is related as a sub-system of the invention “Mobile Care Framework,” for which a patent application is presently pending under U.S. 60/461,886, Filing Date: Apr. 11, 2003 (the disclosure of which is incorporated herein). The Smartphone Profiler System and Method leverages the power of next generation devices and wireless packet data networks to provide an automated method of obtaining accurate and timely diagnostic data from these devices. This will result in faster, efficient and more accurate customer support for the rapid resolution of problems. The advantages of the present invention include the following:
Reduced overall resolution times
Reduced average call handling times (ACHT)
Reduced number of call escalations
Superior method of diagnosis through automated device data collection and presentation to the CSR
Increased customer satisfaction.

The Smartphone Profiler System software is designed to gather and download detailed information from a subscriber's device. Such data can include a current list of applications, configuration settings, diagnostic data, memory allocation, connection data, privacy and security settings. Using this data, customer problems can be accurately identified and effectively resolved. The data collected or obtained from the subscriber's device is presented to the CSR for validation and troubleshooting purposes. This data can also be used to compare current settings versus required settings in a resident database that is updated frequently by the development and service provider community of known bugs, problems and upgraded software/hardware information.

The typical support experience for technology products forces both end users and customer service representatives to wade through highly technical Web sites, complex documentation, or long and cryptic ‘question and answer’ sessions to get the information they need. The present invention streamlines this process by simplifying the support experience for subscribers and support technicians alike.

The present invention has been designed to solve mobile data problems with a minimum of input from either the subscriber or the CSR. Automating the identification of the problem by accurately obtaining device-specific information can help service providers achieve maximum efficiency for timely, targeted solutions to subscriber inquiries. Additional modules for the “Mobile Care Framework” can be used to apply analytics such as to identify differences in application or firmware settings and to upload configuration settings required to troubleshoot application issues or bugs.

The present invention is intended to simplify the customer care process by automating the data collection required to troubleshoot customer's smartphone profiles. Using Over the Air (OTA) Technologies such as SMS or IP based communications (like GPRS, 1XRTT) the Smartphone Profiler sends a request to the subscriber's device to obtain profile settings. The device then gathers this data and sends it back using any one of the mechanisms mentioned above. This data is presented to the CSR for diagnostics purposes.

It is an aspect of the invention to provide a profiling method using a device agent within a mobile device in communication with a server for providing customer care to the mobile device. The method comprises the following steps:
a. in response to a request from the server for a profile of the mobile device, activating a device profiler within the device agent capable of:
   i. gathering profile data from the mobile device; and
   ii. packaging the profile data into one or more data streams;
b. attempting to transmit the one or more data streams to the server by a selected first communication protocol; and
c. on detection of a failure in the transmitting step, attempting retransmission of the one or more data streams to the server by a selected second communication protocol.

The server is preferably capable of invoking a corrective action on the mobile device based on the profile data received.

Where multiple data streams are used, each of the data streams preferably comprises a unique event ID that enables the server to re-assemble the data streams received by the server into a coherent profile for customer care analysis. The data streams may be of a pre-selected size to facilitate transmission according to the selected first or second communication protocol. The one or more data streams may be encrypted prior to transmission.

The profile data may comprise data in XML format. The profile data may also, or in the alternative, comprise data in ASCII format (which may be delimited for parseability).

The profile data relates to the settings and characteristics of the individual mobile device (smartphone). The data preferably comprises one or more types of data selected from the group consisting of device manufacturer, model, revision, OEM information, processor type and architecture, software and hardware platforms, OS major version, OS minor version, OS build number, total physical memory, available physical memory, memory load, AC power, battery strength, signal strength, Cell ID, SMS service center, voice mail number, connection settings, installed applications, state of applications whether running or not, user information including user name and password. This list is not exhaustive of the types of profile data that may be gathered.

Preferably, the first communication protocol comprises TCP/IP. Preferably, the second communication protocol comprises SMS. However, the first and second communication protocols may be any communication protocols that are suitable for reliable transmission of profile data in standard data formats, such as XML or ASCII. The second communication protocol will typically be a less efficient protocol, which is effective as a “fallback” or “failover” option in the event the first communication protocol fails or is not accessible for whatever reason.

It is a second aspect of the invention to provide a device profiler system within a device agent installed on a mobile device, in communication with a server, for providing customer care to the mobile device. The system comprises:
a. a device listener for receiving a request from the server for a profile of the mobile device;
b. a device profiler activated in response to the device listener capable of:
   i. gathering profile data from the mobile device; and
   ii. packaging the profile data into one or more data streams;
c. a device transmitter capable of:
   i. attempting transmission of the profile data to the server by a first communication protocol; and
   ii. if the first communication protocol is not available, or if the transmission at (i) fails, attempting retransmission by a second communication protocol.

Although a smartphone is used as the preferred embodiment in the present application, other types of mobile devices can also be used, such as a personal data assistant (PDA), or any type of wireless-networked computer, including a computer embedded in an appliance. For instance, the “smartphone” could in fact comprise a PDA or advanced PDA, a mobile terminal, a camera, a toy, a gaming station, a vending machine, a vehicle, an appliance (such as a microwave oven or a coffee maker), or practically any kind of device capable of using data transmission means for communication.

### BRIEF DESCRIPTION OF THE FIGURES

FIG. 1 shows a logical diagram of the hardware components of invention according to the preferred embodiment.

FIG. 2 shows a flow diagram of the method used by the Smartphone Profiler to contact a smartphone device to obtain profile data.

FIG. 3 shows a logical diagram of the software sub-components of the embedded smartphone device agent, according to the preferred embodiment.

FIG. 4 shows a logical diagram of the Device Listener, a software sub-component of the embedded device agent.

FIG. 5 shows a flow diagram of the process of requesting a device profile, showing the “heartbeat” mechanism (i.e. keep alive), which is employed to continue communication with the Smartphone Profiler server-side components during the device data download process.

FIG. 6 shows a flow diagram of the Profile Listener, a software component on the on the application server, which listens for incoming profile data.

FIG. 7A shows the method for extracting data from the smartphone device profile (using key-value pairs) to make the profile suitable for GUI presentation and storage in the database.

FIG. 7B shows a diagram illustrating the parsing of nested elements to classify nested XML elements.

FIG. 8 shows a flow diagram of the keep alive request process between the CSR GUI console and the device agent while the data download is in process.

FIG. 9 shows a screen diagram of a sample CSR GUI, according to the preferred embodiment.

### DETAILED DESCRIPTION OF THE PREFERRED EMBODIMENT

The Smartphone Profiler System is composed of two types of components: the device-side and the server-side components. The server-side components can invoke the device-side components, which then probe the device, gather the relevant information and then send it to the server-side components using any of a number of transport methods. Some examples of currently existing transports include SMS, GPRS, WAP, and 1XRTT, but adaptation for other transports is possible and would be within the skill of persons knowledgeable in the art.

Once the server-side component has received the subscriber's smartphone device profile data, it parses the data for presentation to the CSR GUI 106. Upon presentation, the device profile is stored in a Device Profile Data Store 107.

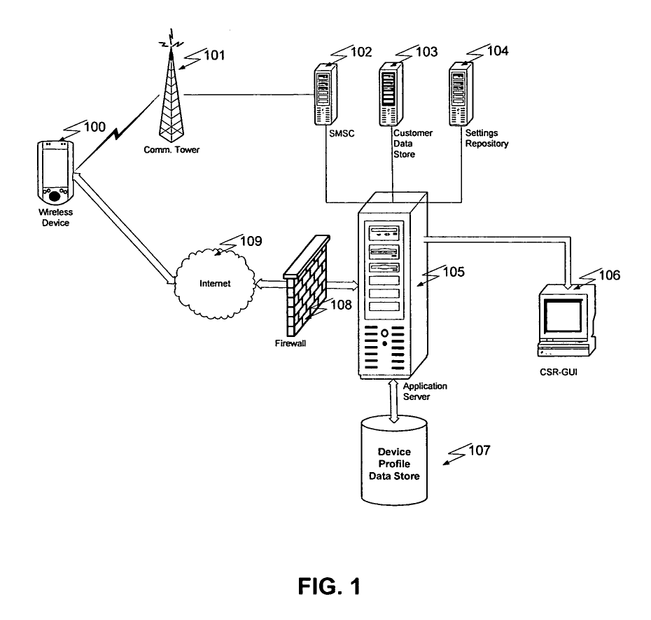

FIG. 1 provides an overview of the Smartphone Profiler and its associated components. The Smartphone Profiler includes the following components: Smartphone Device Agent (SDA) (resident in the wireless device 100), Profile Listener, Parsing Engine (both resident on the application server 105), CSR GUI 106, Device Profile Data Store 107.

The Smartphone Device Agent is a software agent installed on a mobile device 100, such as a wireless smartphone. If a subscriber has a device 100 that does not have an SDA, one can be downloaded to the device 100 when the need arises. One such device agent is part of the SmartCare suite of customer care utilities offered by Biffone, Inc.

The Profile Listener is a server-based component residing on an application server 105 which receives profile data from both SMS 101 and TCP/IP (Internet) 109 connections sent by the SDA. The Profile Listener uses validation mechanisms to determine the parser to use.

The Parsing Engine parses the smartphone device profile data gathered by the SDA so that it can be displayed in the CSR GUI 106 and later archived in the Device Profile Data Store 107. The Parsing Engine is also a server-based component and resides on an application server 105. One such proprietary parsing engine is provided as part of the SmartCare suite offered by Biffone, Inc.

The Graphical User Interface (GUI) 106 is used by the Customer Service Representative (CSR) for viewing and analysis of the smartphone's device profile data. The CSR can also invoke the process of requesting a profile of a user's device through the GUI. Alternatively, the user can use interactive voice response (IVR) or a self-care portal for initiating a device profile.

The Device Profile Data Store 107 consists of one or more databases used in the process of gathering, classifying and analyzing smartphone device profile data that has been collected from various devices 100 over a period of time.

The Device Profile Data Store 107 contains all customer-specific profile information (such as number of soft resets, recently used applications, installed application list) where the information is unique to a specific customer and device-specific profile information (such as processor-type, flash ROM size, firmware version, screen resolution).

The Data Store 107 may be hosted by any JDBC-compliant database system. Connectivity to the Data Store 107 preferably is achieved via JDBC. Preferably, connectivity from the application server 105 is handled by a connection pool where a set number of connections are established by the application server 105, and distributed to threads that require a database connection.

The data store is used to store and classify device data. Once the Profile Listener triggers a request for storage, the data store 107 inserts subscriber account information and device profile information into its database.

In the preferred embodiment, the application server 105 uploads a SDA to a smartphone device 100. The SDA is used to gather and download diagnostic information from the device 100 for troubleshooting purposes. Smartphone devices 100 include GPRS, CDMA2000, UMTS, cradled smartphones and WiFi enabled smartphones. The SDA can be uploaded to the smartphone devices via Over-the-Air (OTA) using, for example, Short Message Service (SMS), WAP push, local methods, including PC cable connection or external storage card, cradle, infra-red, Bluetooth, and other similar mechanisms.

The data collected by the SDA can be divided into two categories:
1. User-specific (unique)
2. Device-specific (non-unique)

Any fields concerning the user-specific data preferably is gathered with subscriber privacy consent. This information is then encapsulated into XML and provisioned to the application server 105. Secure communication can be established by using HTTPS/SSL encryption or public key/private key exchange.

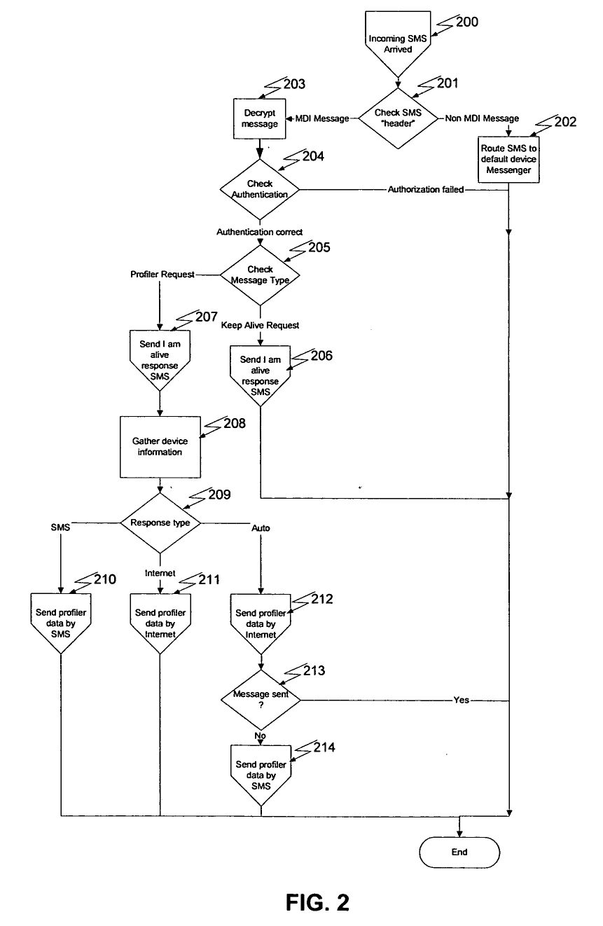

An overview of the process of receiving profile data from devices 100 is illustrated in FIG. 2.

FIG. 2 is a flow chart of an exemplary profiling activity conducted by a Smartphone Device Agent in a mobile device. At a start block 200, an incoming SMS message is received by the device. Later, at a decision box 200, the SMS header is checked to determine if the received SMS message is a diagnostic message (also referred to as an MDI message). If it is determined that the received message is not a diagnostic message, then, at a next block 202, it is routed to a default SMS handler in the device (also referred to as the default device messenger).

If, at the decision box 200, it is determined that the received message is a diagnostic message, then, at a next block 203, the message is decrypted. Then, at a next decision box 204, the message is checked for authentication. If it is determined that the authentication is improper or inadequate, then, processing of the received message terminates at an end block. Otherwise, at a next decision block 205, the message type is checked.

If, at the decision box 205, it is determined that the message type is session related, such as a “keep session alive” request, then at a next block 206, an “I am alive” response is communicated back to the sender, i.e. the customer care system or other systems that initiated the activity. Such a message may be communicated over an SMS bearer. After the “I am alive” message is communicated, the processing terminates at the end block.

If, at the decision box 205, it is determined that the message type is “profiler request”, then, at a next block 207, an “I am alive” message is communicated. Then, at a next block 208, device information is gathered. This involves invoking one or more API's, some of them provided by an operating system in the device, to retrieve information on the various status of the device, the operator network, provisioned information, configurations, and applications running on the device. The gathered information is then made ready to be sent as a response comprising a profiler data. Then, at a next decision block 209, the response type required is determined. Response type can be SMS response, Internet response and auto (one of Internet or SMS).

If it is determined that the response type needs to be an SMS type, then at a next block 210, the response comprising the profiler data is sent via SMS and processing terminates at the end block.

If it is determined that the response type needs to be an Internet type, then at a next block 211, the response comprising the profiler data is sent via Internet and processing terminates at the end block.

If it is determined that the response type needs to be auto, i.e. an Internet type or SMS type, then at a next block 212, the response comprising the profiler data is sent via Internet. At the next block 213, an attempt is made to determine if the response was sent successfully. If it is determined that the response was sent successfully, then processing terminates at the end block. Otherwise, at a next block 214, the response is sent over SMS and processing terminates at the end block.

The Profile Listener, which resides on the application server 105, listens for incoming smartphone device profile data and passes received data to the Parsing Engine. The Parsing Engine then extracts the device profile data and makes it suitable for viewing in the CSR GUI 106 and for storage in the Device Profile Data Store 107.

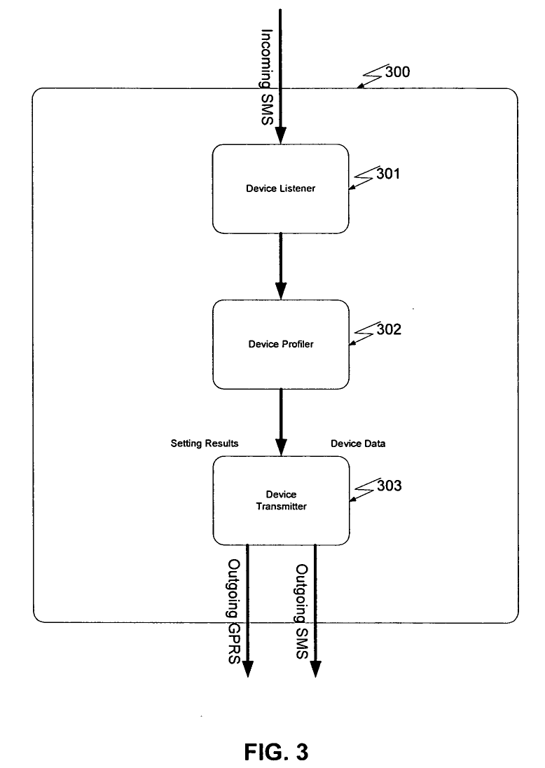

Preferably, as shown in FIG. 3, the SDA comprises three components:
DeviceListener 301
DeviceProfiler 302
Device Transmitter 303

The DeviceListener 301 listens for requests coming from the application server 105. The DeviceProfiler 302 gathers the device profile data from the smartphone device 100. Gathered data which includes information such as available memory, available storage, installed applications, battery life, connection/signal strength, connection settings, user requests, usage statistics, and soft reset count is sent to the application server by the Device Transmitter 303.

DeviceListener 301, a component of the SDA residing on the smartphone device 100, continuously runs in the background. The DeviceListener 301 receives an SMS request from the application server 105 to collect the smartphone device profile. The DeviceListener 301 then executes the DeviceProfiler 302, which in turn begins to collect this information. Once this information is gathered, it is sent to the application server 105, preferably either by GPRS (IP technology) or SMS.

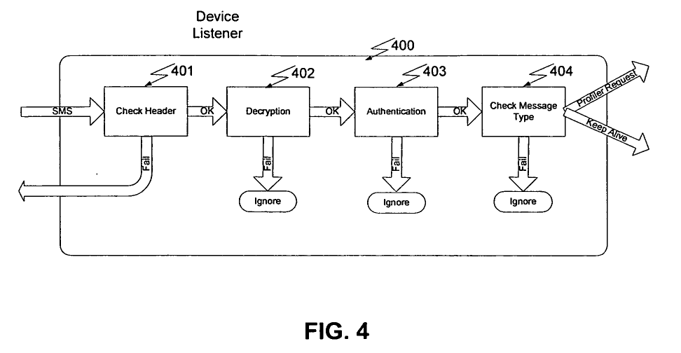

Turning to FIG. 4, the responsibilities of the DeviceListener 400 are described. The DeviceListener 400 module responds to requests sent from the application server 105. During the initialization process (analogous to turning on the radio), the DeviceListener 400 registers itself to receive SMS messages that contain a specific header 401. When the device receives an SMS, it validates it and routes the message to the appropriate location according to the header 401.

In order to ensure that only authorized profiles are returned, the application server can encrypt the request messages. The decryption 402 will use one of several algorithms set by the server. The selected algorithm code is contained in the header, thus enabling the SDA 300 to recognize the request.

After encryption/decryption 403, authentication is the secondary security mechanism used by the SDA 300. This authentication code is preferably wireless carrier specific and is preferably implemented during deployment. Authentication preferably employs one of MD5, RSA-SH1, CRC, HMAC, digital signatures, etc.

Typically, a message type is associated/incorporated into the message to help the device listener distinguish profiler requests from session related messages, such as a “keep session alive” message. For example, in one embodiment, a value of 1 assigned to a message type would indicate a message to be of type “profiler request” while a value of 0 would indicate that it is of type “keep session alive”. Other message types are also contemplated.

The Device Profiler gathers device information and settings. The profile data is divided into two categories:
1. Common
2. Device Specific

The Device Transmitter is responsible for sending data to the application server. Preferably, TCP/IP is used as the primary mode of transport. In the event that IP technology is interrupted or unavailable for sending the device profile data, SDA reverts to a second or fallback technology, such as SMS, in order to continue with the downloading process. The fail over logic is used when either the subscriber is making a phone call is in progress or if there is a problem establishing the TCP/IP connection.

To address the present limitations of the SMS technology, which restricts packet data to a maximum of 160 characters per packet; when using SMS transport mode, the Device Transmitter splits the profile into chunks. Such chunks are sized to fit within the wireless carrier's SMS character limit (usually around 140 to 160 characters). Preferably, each of these chunks is also assigned a Profiler Event ID which allows the application server to recognize and reassemble them.

The SDA is designed to include a validation mechanism, which ensures the number of packets sent by the SDA match the number of packets received. If there is an incorrect match found, an error message is presented to the CSR indicating that the profiling process failed. A retry mechanism exists on the server side, and the mechanism is invoked if it does not receive all the data the server is expecting.

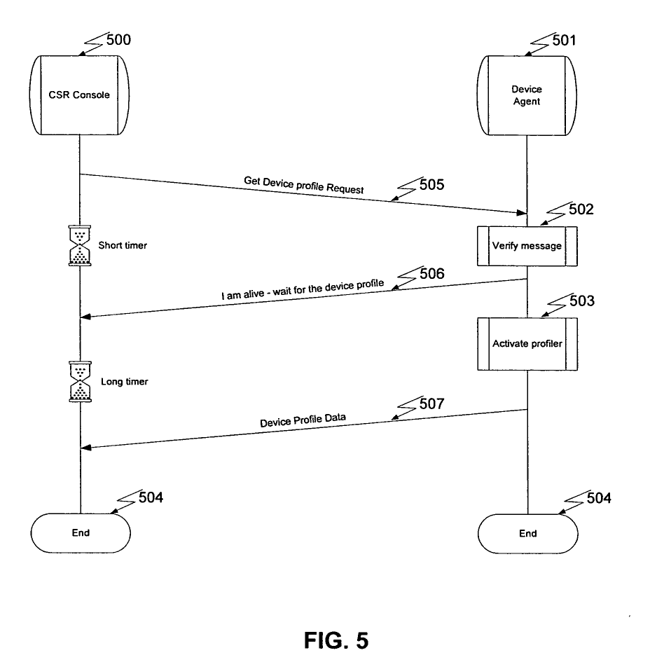

As shown in FIG. 5, the Profile Request 505 message is one of the message types supported by the device agent 501. This message is sent by the application server 105 when initiated by the CSR 500 to request a device profile. Receiving the full profile 507 may take some time, so the device agent 501 replies immediately with the SMS message “I am alive” 506. This allows for the progress information to be shown on the screen for the CSR 500.

The verify message activity 502 of the device agent 501 invokes verification of the authenticity and appropriateness of the message. For example, it may involve checking the header of the received message, authenticating the message, checking the message type to ensure it is a valid one, decrypting the contents, if necessary, etc.

Once all required information is gathered by the SDA 501, the SDA 501 sends the data to the Profile Listener preferably by SMS or TCP/IP. Preferably, the SDA tries a more efficient method first such as TCP/IP, but automatically fails over to a secondary method, such as SMS.

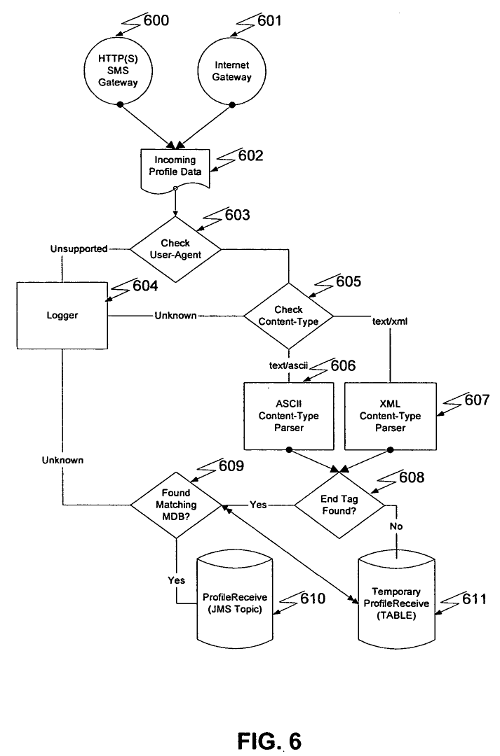

The Profile Listener resides on the application server 105. FIG. 6 shows the process flow for an incoming profile detected by the Profile Listener. The Profile Listener receives incoming profile data 602 from both SMS 600 and TCP/IP (Internet) 601 connections. The Profile Listener then uses the User-Agent 603 and Content-Type 605 to determine which parser to use, in this case either ASCII 606 or XML 607. The Profile Listener creates a message for processing by the Input Processors and uses the appropriate parser to create a hash table 611 of the name value pairs sent from the device agent.

If the user agent is determined to be an unknown agent at the decision block 603, then, at a next block 604, the message is logged using a logger. Subsequently, at a next block 609, an attempt is made to determine an associated message driven bean (MDB) associated with a JMS service. Typically a MDB is composed of at least 3 parts, a Message Driven Bean implementation class, an MDB definition in the EJB (ejb-jar.xml) deployment descriptor, and an MDB definition in the vendor specific deployment descriptor (here jboss.xml).

If an associated MDB can be determined at 609, then the received message, logged by the logger, of an unknown user-agent type, is forwarded to the ProfileReceive JMS topic 610. Again, during the parsing of the received message, such as during an XML parsing, an end tag is encountered at 608, then the received data (set of tags and associated values) is processed at 609 to determine an associated MDB and, if found, forward the data to the ProfileReceive JMS topic at 610. In general, a JMS topic identifies a publish/subscribe JMS destination for a JMS server. During the configuration of a JMS server, one or more topic destinations are configured. The ProfileReceive 610 is a JMS topic that receives parsed XML or ASCII messages for further processing.

The Parsing Engine is responsible for extracting data from the smartphone device profile and making it suitable for presentation and storage in the Device Profile Data Store 107. The XML Parser 607 parses each XML element and generates key-value pairs based on the XML tag and the content. The XML Start tag 607 becomes the key while the content between the start 607 and end 608 tags become the value forwarded to a ProfileReceive JMS topic 610.

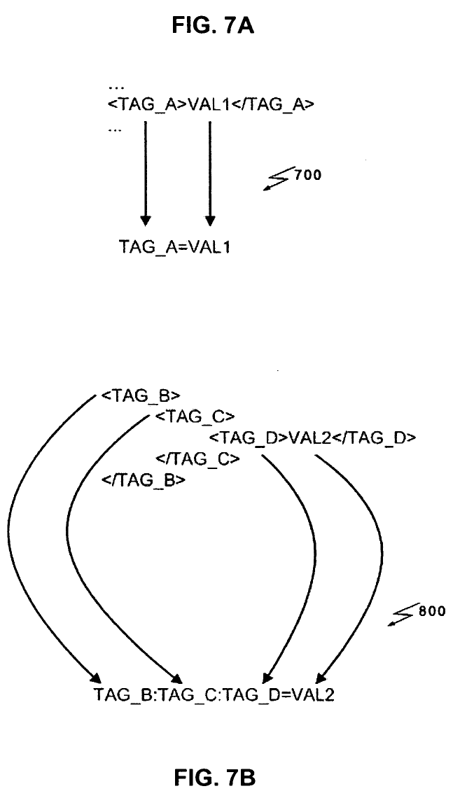

The process for parsing nested XML elements is shown in FIGS. 7A and 7B. Non-nested XML elements are parsed by keying 700 the value between the start and end tags as noted above. For nested elements, the XML Parser will form the key by concatenating the XML tags until it reaches the innermost element, as shown at 800. The data within the innermost element will constitute the value. Nested XML elements are used to represent more complex device profile settings such as connection information and software list, where there could be multiple settings for the category. Preferably, no attributes are used.

For example, the XML Parser might generate the following key-value pairs from the parsed XML elements:
ESN=35537831545
TOTAL_MEM=163775376
CONNECTION_SETTINGS:CONN_{—}1:NAME=Wireless Carrier1
CONNECTION_SETTINGS:CONN_{—}1:USERNAME=name1
CONNECTION_SETTINGS:CONN_{—}1:PASSWORD=password1
CONNECTION_SETTINGS:CONN_{—}2:NAME=Wireless Carrier2
CONNECTION_SETTINGS:CONN_{—}2:USERNAME=name2
CONNECTION_SETTINGS:CONN_{—}2:PASSWORD=password2

In order to reduce the size of the device profile data, a compression algorithm may be implemented as part of its parsing engine.

To illustrate, an XML Profile Document preferably has the following format:

```
<PROFILE>
    ...
    <ESN>355378315</ESN>
    <TOTAL_MEM>163775376</TOTAL_MEM>
    ...
    <CONNECTION_SETTINGS>
        <CONN_1>
            <NAME>Wireless Carrier1</NAME>
            <USERNAME>name1</username>
            <PASSWORD>password1</PASSWORD>
        </CONN_1>
        <CONN_2>
            <NAME>Wireless Carrier2</NAME>
            <USERNAME>name2</username>
            <PASSWORD>password2</PASSWORD>
        </CONN_2>
        ...
    </CONNECTION_SETTINGS>
...
</PROFILE>
```

In summary, each XML element under the root element represents a specific type of device profile setting while the content between the start and end tags represent the actual value for that device profile setting.

An example of device parameters gathered using the Smartphone Profiler System and Method is shown below.

| Parameter | Description | Sample Values |
|---|---|---|
| Manufacturer | Phone Manufacture | HTC |
| | name | |
| Model | Phone Model | Canary |
| Revision | Phone H/W Revision | 1.2.1 |
| OEM Info | Phone OEM Information | ORG_NL |
| Platform | Phone H/W Platform | MS Smartphone |
| Signal Strength | Radio Signal Strength | 74% |
| Cell ID | Radio Cell Id number | 12004 |
| SMS Service Center | Service Center Number | 17057969300 |
| Voicemail Number | Voicemail Number | +14163581549 |
| AC Power | Is it plugged in to | On battery power |
| | external power supply | |
| Battery Strength | Battery strength in % | 68% |

| | Phone configuration | |
|---|---|---|
| Profile | profile (ex. Silent mode) | Normal |
| Processor | CPU Type | 5 |
| Architecture | | |
| Processor Revision | CPU revision | 2 |
| OS Major Version | OS Major Version | 3 |
| OS Minor Version | OS Minor Version | 0 |
| OS Build Number | OS Build Number | 12312 |
| Memory Load | Calculation of memory | 47% |
| | load | |
| Avail Physical | Physical Memory | 6 MB |
| Memory | available | |
| Total Physical | Total amount of physical | 12 MB |
| Memory | memory | |
| Installed Application | List of all installed | MSN Messenger 4.2 |
| list | applications | Windows Media |
| | | Player |
| | | Image Viewer |
| | | Pocket Word |

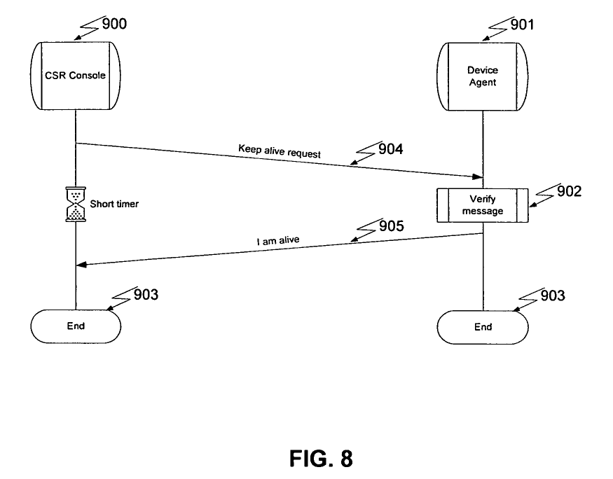

Preferably, as shown in FIG. 8, a Keep Alive Request (PING) message 904 may be used to verify 902 that the device has an SDA installed and is responding to requests sent by the application server 105. The status is preferably displayed on the CSR GUI 900.

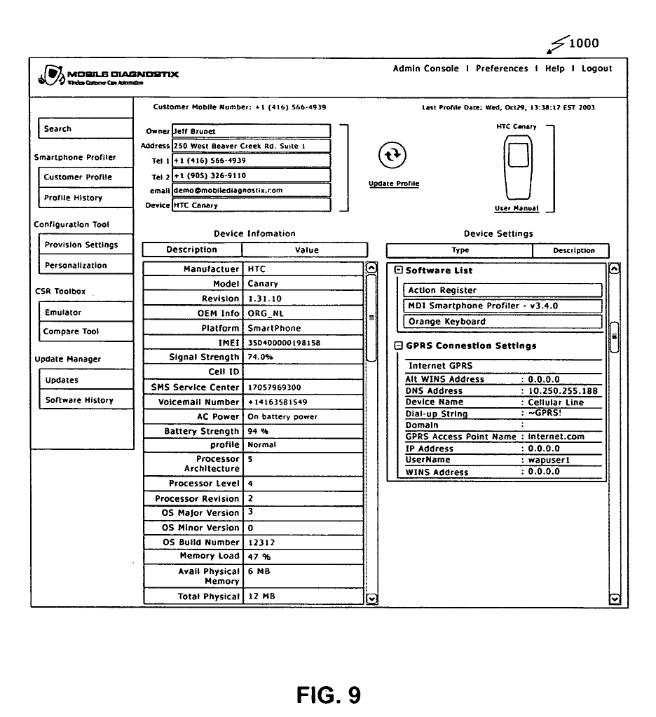

The CSR GUI is the user-interface and is a web-based XML-driven dynamic system; controlled by the application server 105 he parsing engine thereon to display the mobile subscriber's device profile data. A sample layout 1000 of the CSR GUI is shown in FIG. 9.

Preferably, the screens use JSPs (Java Server Pages) for layout and branding 10 customizations. Preferably, the session management and transactional logic are handled via the application server 105 using EJB technologies (Session Beans, Entity Beans). By using EJB or an equivalent, future branding and/or text changes can be made without customizations to the application logic.

The JSPs dynamically generate the screens and the relevant information based on the access-level of the Customer Service Support Representative.

The foregoing is considered as illustrative only of the principles of the invention. Further, since numerous modifications and changes will readily occur to those skilled in the art, it is not desired to limit the invention to the exact processes, components and applications shown and described, and accordingly, all suitable modifications and equivalents may be resorted to, falling within the scope of the invention and the appended claims and their equivalents. For instance, the “smartphone” could in fact comprise a PDA or advanced PDA, a mobile terminal, a camera, a toy, a gaming station, a vending machine, a vehicle, an appliance (such as a microwave oven or a coffee maker), or practically any kind of device capable of using data transmission means for communication.

List of Acronyms

Industry Specific Acronyms

ESN Electronic Serial Number. It is a 32-bit identifier of a mobile device and used in TDMA, CDMA or AMPS networks.
IMEI International Mobile Equipment Identity. It is a 56-bit identifier used in the GSM networks.
OTA Over-the-Air. A standard for the transmission and reception of application-related information in a wireless communications system. In addition to short messages and small graphics, files can contain instructions for subscription activation, banking transactions, ringtones, and Wireless Access Protocol (WAP) Settings.
WAP Wireless Application Protocol.
GSM Global System for Mobile Communications.
GPRS General Packet Radio Service. A GSM based packet data protocol using up to all 8 of the time slots in a GSM Channel.
SMS Short Message Service.
CDMA Code Division Multiple Access.
1XRTT CDMA2000 Radio Transmission Technology (1X-RTT), a wide-band, spread spectrum radio interface that uses Code Division Multiple Access (CDMA) technology to meet the needs of third generation (3G) wireless communications systems.
GUI Graphical User Interface.
XML Extensible Markup Language.
JMS Java Message Service.
JSP Java Server Pages.
ODBC Open Database Connectivity, a standard database access method.
   Invention Specific Acronyms
MCF Mobile Care Framework
SDA Smartphone Device Agent

1. A profiling method using a device agent within a mobile device in communication with a server for providing customer care to the mobile device, comprising:
a. in response to a request from the server for a profile of the mobile device, activating a device profiler within the device agent capable of:
i. gathering profile data from the mobile device; and
ii. packaging the profile data into one or more data streams;
b. attempting to transmit the one or more data streams to the server by a selected first communication protocol; and
c. on detection of a failure in the transmitting step, attempting retransmission of the one or more data streams to the server by a selected second communication protocol;
wherein the server is capable of invoking a corrective action on the mobile device based on the profile data received.

2. The profiling method of claim 1, wherein each of the data streams comprises a unique event ID that enables the server to re-assemble the data streams received by the server into a coherent profile for customer care analysis.

3. The profiling method of claim 1, wherein step (a) of the method further comprises splitting the profile data into a plurality of data streams of a pre-selected size to facilitate transmission according to the selected first communication protocol.

4. The profiling method of claim 1, wherein step (c) of the method further comprises splitting the profile data into a plurality of data streams of a pre-selected size to facilitate transmission according to the selected second communication protocol.

5. The profiling method of claim 1, wherein the profile data comprises data in XML format.

6. The profiling method of claim 1, wherein the profile data comprises data in delimited ASCII format.

7. The profiling method of claim 1, wherein the method further comprises encrypting the one or more data streams prior to transmission.

8. The profiling method of claim 1, wherein the profile data comprises one or more types of data selected from the group consisting of device manufacturer, model, revision, OEM information, processor type and architecture, software and hardware platforms, OS major version, OS minor version, OS build number, total physical memory, available physical memory, memory load, AC power, battery strength, signal strength, Cell ID, SMS service center, voice mail number, connection settings, installed applications, state of applications whether running or not, user information including user name and password.

9. The profiling method of claim 1, wherein the first communication protocol comprises TCP/IP.

10. The profiling method of claim 1, wherein the second communication protocol comprises SMS.

11. A device profiler system within a device agent installed on a mobile device, in communication with a server, for providing customer care to the mobile device, the system comprising:
a. a device listener for receiving a request from the server for a profile of the mobile device;
b. a device profiler activated in response to the device listener capable of:
i. gathering profile data from the mobile device; and
ii. packaging the profile data into one or more data streams;
c. a device transmitter capable of:
i. attempting transmission of the profile data to the server by a first communication protocol; and
ii. if the first communication protocol is not available, or if the transmission at (i) fails, attempting retransmission by a second communication protocol;
wherein the server is capable of invoking a corrective action on the mobile device based on the profile data received.

12. The device profiler system of claim 11, wherein each of the data streams comprises a unique event ID that enables the server to re-assemble the data streams received by the server into a coherent profile for customer care analysis.

13. The device profiler system of claim 11, wherein the system is further capable of splitting the profile data into a plurality of data streams of a pre-selected size to facilitate transmission according to the selected first communication protocol.

14. The device profiler system of claim 11, wherein the profile data comprises data in XML format.

15. The device profiler system of claim 11, wherein the profile data comprises data in delimited ASCII format.

16. The device profiler system of claim 11, wherein the system is further capable of encrypting the one or more data streams prior to transmission.

17. The device profiler system of claim 11, wherein the profile data comprises one or more types of data selected from the group consisting of device manufacturer, model, revision, OEM information, processor type and architecture, software and hardware platforms, OS major version, OS minor version, OS build number, total physical memory, available physical memory, memory load, AC power, battery strength, signal strength, Cell ID, SMS service center, voice mail number, connection settings, installed applications, state of applications whether running or not, user information including user name and password.

18. The device profiler system of claim 11, wherein the first communication protocol comprises TCP/IP.

19. The device profiler system of claim 11, wherein the second communication protocol comprises SMS.
